(19) United States
(12) Patent Application Publication
(10) Pub. No.: US 2001/0054113 A1
(43) Pub. Date: Dec. 20, 2001

(54) Communication system

(76) Inventor: Moritsugu Nishida, Fukuoka-shi (JP)

Correspondence Address: STEVENS, DAVIS, MILLER & MOSHER, L.L.P., 1615 L Street, N.W., Suite 850, Washington, DC, 20036, US

(21) Appl. No.: 09/852,013

(22) Filed: May 10, 2001

(30) Foreign Application Priority Data
May 31, 2000 (JP) 2000-162022

(51) Int. Cl. G06F 15/16; H04M 1/64

(52) U.S. Cl. 709/245; 379/68

(57) ABSTRACT

In a communication system, a file communication apparatus includes an address management portion for storing information about a corresponding relationship between a telephone number of a telephone set and a network address of a computer, a file receiving portion for receiving the network address and the voice file which are transmitted from the computer, a file storing portion for storing the received voice file, a DA conversion portion for converting the stored voice file into a voice signal, and a telephone control portion for transmitting the voice signal. The file communication apparatus further includes a main control portion which obtains the telephone number corresponding to the received network address based on the relationship in the address management portion, and controls the telephone control portion to transmit the voice signal to the telephone set corresponding to the obtained telephone number.

### BACKGROUND OF THE INVENTION

1. Field of the Invention

This invention relates to a communication technology in communication for E-mail on a network, especially to a communication system for transmitting and receiving a voice file attached to the E-mail on the network.

2. Description of the Related Art

In recent years, in communication between personal computers, use of an E-mail which includes character information has prospered by development of computer network technology. Moreover, as communication information different from character information, use of the voice file attached to the E-mail has also increased.

Specifically, the latest personal computer has a speaker for itself, and a user can hear sound of the voice file attached to the E-mail received from the mail server, from the speaker.

### SUMMARY OF THE INVENTION

An object of the invention is to provide a communication system having high convenience and cost performance in use, which includes a plurality of computers connected to a network and a plurality of telephone sets each of which is disposed to be corresponded to one of those computers.

A communication system according to the invention comprises: a mail server for receiving and storing a mail, to which a voice file is attached, through a network; a plurality of computers for receiving the mail from the mail server through the network; a file communication apparatus for receiving the voice file through the network; and a plurality of telephone sets connected to the file communication apparatus, wherein each of the telephone sets is disposed in correspondence with one of the computers.

The communication apparatus includes: management means for storing information about a corresponding relationship between telephone numbers of the telephone sets and network addresses of the computers; receiving means for receiving the network address and the voice file which are transmitted from one of the computers; storing means for storing the voice file received by the receiving means; conversion means for converting the stored voice file into a voice signal; transmitting means for transmitting the voice signal; and control means for obtaining the telephone number corresponding to the received network address based on the relationship in the management means, and for controlling the transmitting means to transmit the voice signal to the telephone set corresponding to the obtained telephone number.

### BRIEF DESCRIPTION OF THE DRAWINGS

FIG. 1 shows a schematic diagram of a communication system according to the 1st embodiment of the invention.

FIG. 2 shows a block diagram of the communication system according to the 1st embodiment of the invention.

FIG. 3 shows a data construction in an address management portion of the communication system according to the 1st embodiment of the invention.

FIG. 4 shows a flow sequence in operation of the communication system according to the 1st embodiment of the invention.

FIG. 5 shows a schematic diagram of a communication system according to the 2nd embodiment of the invention.

FIG. 6 shows a block diagram of the communication system according to the 2nd embodiment of the invention.

FIG. 7 shows a flow sequence in operation of the communication system according to the 2nd embodiment of the invention.

FIG. 8 shows a flow sequence in operation in another mode of the communication system according to the 2nd embodiment of the invention.

FIG. 9 shows a schematic diagram of a communication system according to the 3rd embodiment of the invention.

FIG. 10 shows a block diagram of the communication system according to the 3rd embodiment of the invention.

FIG. 11 shows a flow sequence in operation of the communication system according to the 3rd embodiment of the invention.

FIG. 12 shows a flow sequence in operation in another mode of the communication system according to the 3rd embodiment of the invention.

### DETAILED DESCRIPTION OF THE EMBODIMENTS

Referring to the drawings, the 1st embodiment of the invention is explained as follows.

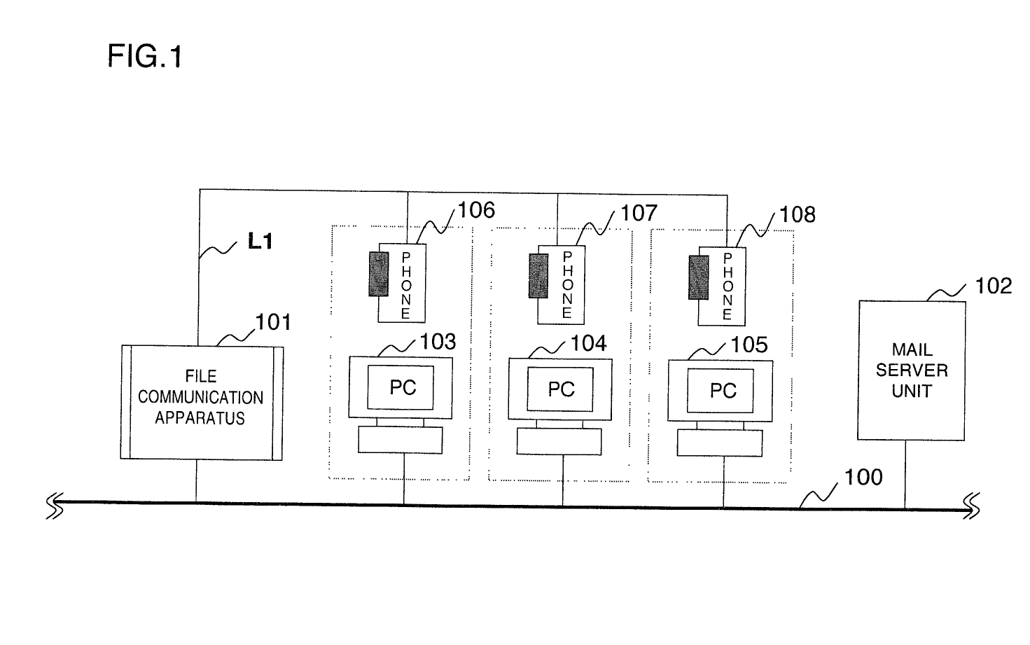

First, with reference to FIG. 1, a schematic structure of the communication system in the 1st embodiment of this invention is explained.

A file communication apparatus 101, a mail server unit 102, three personal computers 103, 104 and 105 are connected with a Local Area Network (LAN) 100. Also, three of the telephone sets for extensions 106, 107 and 108 are connected with the file communication apparatus 101 and each other through a connection line L1. Further, each personal computer 103, 104 or 105 is disposed in correspondence with one of the telephone sets 106, 107 and 108. Also, the telephone set 106, 107 or 108 is the type of the conventional analog standard telephone set. Each personal computer 103, 104 or 105 connected with the LAN 100 is capable of transmitting/receiving an E-mail to/from the mail server unit 102.

Also, each personal computer 103, 104 or 105 has lots of hardware such as a CPU, a memory and a modem, and can perform various kinds of functions each of which can be operated on a display screen of the personal computer.

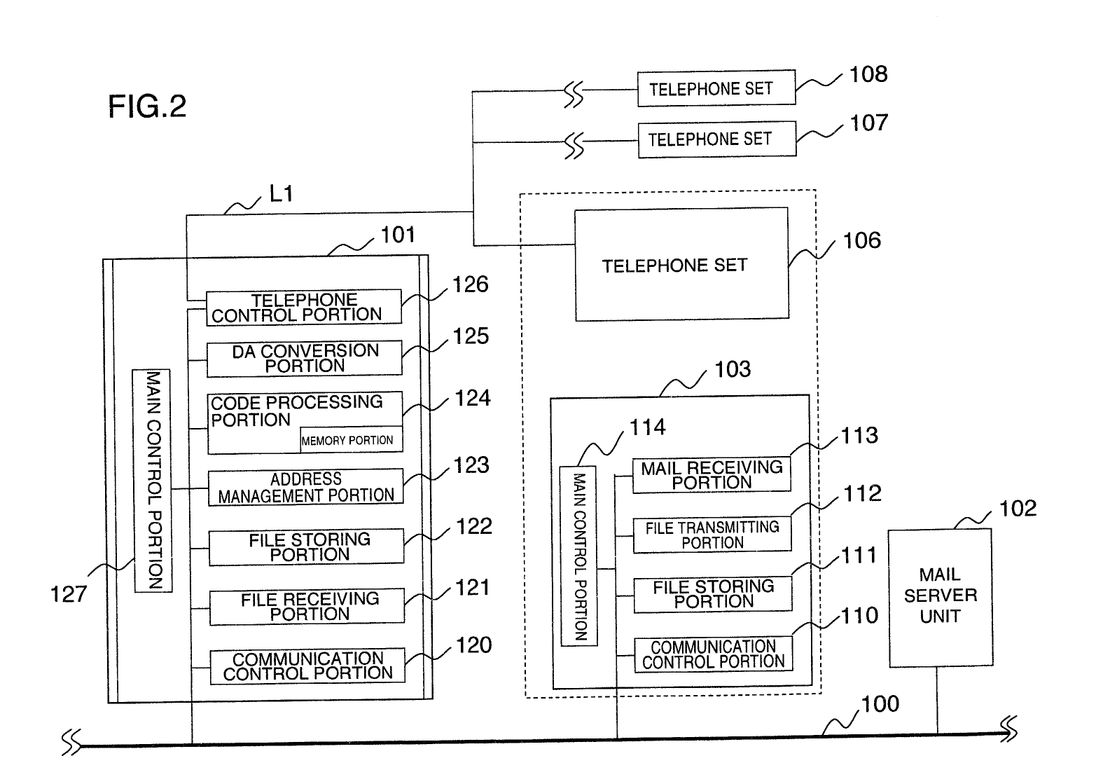

With reference to FIG. 2, a structure and a function of the personal computer 103 are explained in detail as an example of the above personal computers. The personal computer 103 has a communication control portion 110 which has a function as a communication interface with the file communication apparatus 101. Also, a mail receiving portion 113 receives the E-mail from the mail server unit 102 through the communication control portion 110. A main control portion 114 transmits a voice file of the E-mail received by the communication control portion 110, to a file storing portion 111, and the file storing portion 111 stores the voice file therein. A file transmitting portion 112 is capable of transmitting the voice file stored in the file storing portion 111. Further, the main control portion 114 has a function for controlling each of the above portions (means) of the personal computer 103.

The file communication apparatus 101 of the embodiment is explained as follows.

The file communication apparatus 101 has lots of hardware such as a CPU, a memory and various kinds of communication means.

In detail, the file communication apparatus 101 has a LAN controller which transmits and receives an Ethernet packet on the LAN 100, and various kinds of software such as a driver software which controls the operation of the LAN controller and a software which controls the network protocol in communication of the Ethernet packets on the LAN 100. Also, the file communication apparatus 101 can perform data communications on the LAN 100.

With reference to the functional block diagram of FIG. 2, the file communication apparatus 101 includes a communication control portion 120 which performs data communication through the LAN 100. The communication control portion 120 has a controller which transmits an Ethernet packet, the software which controls the operation of the controller, and the software for network communication.

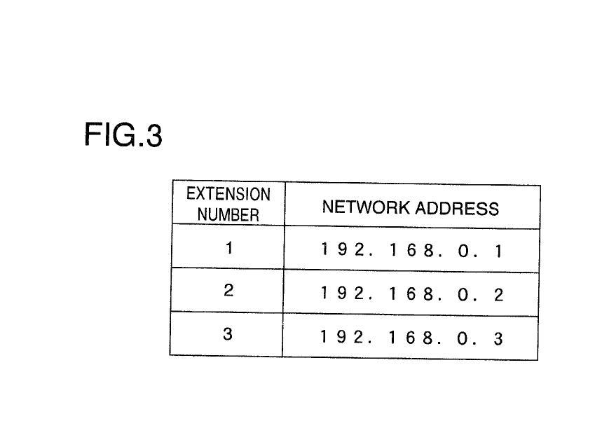

A file receiving portion 121 receives a voice file through the communication control portion 120 which has the data communication function. Also, a file storing portion 122 stores the voice file which the file receiving portion 121 received. An address management portion 123 stores the extension numbers of the telephone sets and the network addresses on LAN of the personal computers, and each telephone number corresponds to one of the network addresses of the personal computers as pairs (referring to FIG. 3).

Next, with reference to FIGS. 1 and 3, the construction of data stored in the address management portion 123 of the file communication apparatus 101 is explained. The telephone set 106 has the extension number “1” corresponding to the network address <192.168.0.1> which the personal computer 103 has. Also, the telephone set 107 has the extension number “2” corresponding to the network address <192.168.0.2> which the personal computer 104 has. Furthermore, the telephone set 108 has the extension number “3” corresponding to the network address <192.168.0.3> which the personal computer 105 has.

Further, a code processing portion 124 processes the received voice file according to an encoding method of a DA conversion portion 125 so that the DA conversion portion 125 can reproduce the voice file, and stores the processed voice file (hereinafter referring to as “voice data”) in a memory portion of the code processing portion 124. The code processing portion 124 transmits periodically to the DA conversion portion 125 a predetermined amount of the voice data coincided with an encoding rate of the DA conversion portion 125. Moreover, the DA conversion portion 125 has a function for converting the voice data into an analog voice signal. The analog voice signal can be converted to sound in the telephone set.

Further, a telephone control portion 126 has a function as the communication interface with the telephone set. Specifically, the telephone control portion 126 has a function for transmitting a bell signal, a function for detecting a hook-state of the telephone set, a function for detecting a tone-dial signal and a pulse dial signal, a function for transmitting and receiving analog voice signals, and a function for supplying an electric power to the telephone set. Moreover, a main control portion 127 controls the above portions (means) of the file communication apparatus 101.

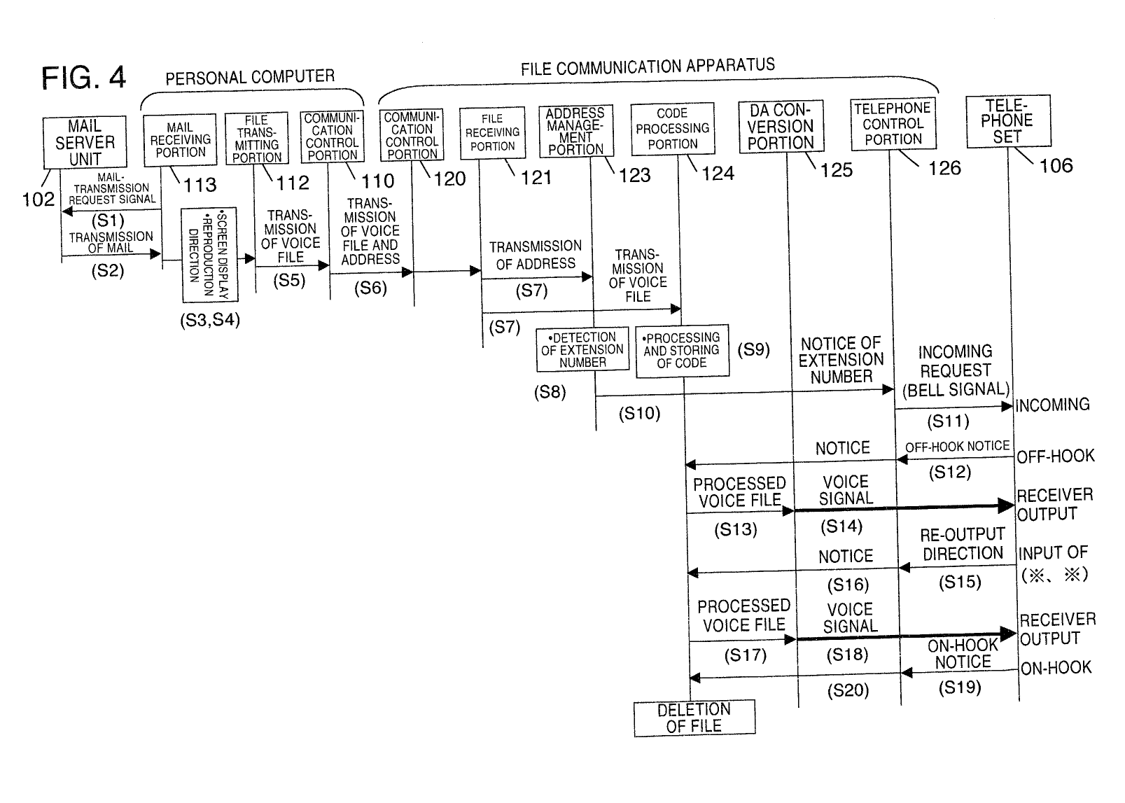

With reference to FIGS. 2 to 4, the schematic sequence flow in the operation of the communication system of the embodiment structured as above is explained as follows.

Specifically, the operation processes from when an E-mail with a voice file from the mail server unit 102 is received by the personal computer 103, until when the telephone set 106 corresponding to the personal computer 103 outputs sound of the voice file received through the file communication apparatus 101 are explained.

First, the personal computer 103 which has the network address <192.168.0.1> transmits a mail-transmission request (signal) to the mail server unit 102 (Step 1). The mail server unit 102 checks an ID password from the personal computer 103, and if it corresponds, transmits the E-mail to the personal computer 103 (Step 2). Next, the mail receiving portion 113 of the personal computer 103 receives the E-mail with the voice file from the mail server unit 102 through the communication control portion 110, and the personal computer 103 displays the contents of the E-mail on the display screen (Step 3).

Since the voice file is attached to the E-mail, the icon of the voice file is displayed on the display screen of the personal computer 103 (not shown). Then, a user performs a voice reproduction direction through the display screen by clicking a computer mouse with a cursor superimposed on the icon of the voice file on the display screen (Step 4). That is, by the click, the main control portion 114 transmits a transmission direction to the file transmitting portion 112 after receiving the voice reproduction direction. By receiving the transmission direction, the file transmitting portion 112 forwards the voice file from the file storing portion 111 to the communication control portion 110 (Step 5). The communication control portion 110 has a memory in which the network address of the file communication apparatus 101 was stored, and is set so as to forward the voice file to the file communication apparatus 101 by receiving the above direction.

Next, the communication control portion 110 forwards the voice file to the file communication apparatus 101 in compliance with the communication protocol after adding the network address of the personal computer 103 to a header portion of the voice file in compliance with the communication protocol (Step 6).

Next, in the file communication apparatus 101, the file receiving portion 121 receives the voice file and the network address attached to the header portion of the voice file, and stores them in the file storing portion 122.

Further, the main control portion 127 transmits the network address <192.168.01> of the personal computer 103 to the address management portion 123 (Step 7). Simultaneously, the main control portion 127 forwards the voice file stored in the file storing portion 122 to the code processing portion 124 (Step 7). Also, the file storing portion 122 deletes the voice file automatically after transmitting the voice file to the code processing portion 124. The voice file is capable of being deleted at step 20 by the direction of the main control portion 127.

After receiving the network address <192.168.01>, the address management portion 123 detects the extension number “1” corresponding to the received network address <192.168.01> on the basis of the relationship (refer to FIG. 3) between the network addresses and the extension numbers (Step 8), and then informs the main control portion 127 of a notice indicating that the corresponding extension number existed in the relationship. Next, the code processing portion 124 processes the voice file in compliance with the encoding method of the DA conversion portion 125, and stores the processed voice file (hereinafter referring to as “voice data”) in the memory portion (Step 9).

After receiving the notice, the main control portion 127 directs the address management portion 123 to transmit the extension number “1” to the telephone control portion 126 (Step 10). Then, the telephone control portion 126 transmits a bell signal (incoming signal), as an off-hook request signal, to the telephone set 106 having the extension number “1” (Step 11). The telephone set 106 generates a bell sound by receiving the bell signal.

When the user hangs off the receiver of the telephone set 106, an off-hook signal (response signal) is transmitted from the telephone set 106 to the telephone control portion 126 of the file communication apparatus 101. Next, the telephone control portion 126 detects the response signal, and transmits the detection result to the main control portion 127 (Step 12). Then, the main control portion 127 directs the code processing portion 124 to transmit the voice data to the DA conversion portion 125.

Next, the code processing portion 124 transmits the voice data to the DA conversion portion 125 according to the coding sampling cycle and the number of coding bits of the DA conversion portion 125 (Step 13). Then, the DA conversion portion 125 converts the digital voice data into an analog voice signal, and transmits the analog voice signal to the telephone set 106 through the telephone control portion 126 (Step 14). The analog voice signal is adapted to be changed to sound in the telephone set 106. Finally, the telephone set 106 outputs the voice file as sound from the receiver of the telephone set 106.

As explained above, the user can hear the sound of the voice file certainly from the start by receiving the analog voice data of the voice file, which is generated by transmitting the digital voice data form the code processing portion 124 to the DA converting portion 125, when the user hangs off the receiver of the telephone set 106.

If the bell signal of the file communication apparatus 101 is different from the bell signal of the extension telephone set 106, the user can know whether the voice mail have reached or not.

Next, after finishing transmitting the voice file, the code processing portion 124 sends a notice of the voice-file transmission finishing to the main control portion 127. Further, the main control portion 127 directs the telephone control portion 126 to transmit a reorder tone signal indicating the voice-file transmission finishing to the telephone set 106, and waits for a response indicating that the line was disconnected (the on-hook signal) from the telephone set 106.

In the embodiment of the invention, however, the user can hear the sound of the voice file from the start again by performing a predetermined key input operation while the telephone control portion 126 is outputting the voice signal or after the telephone control portion 126 finishes transmitting the voice signal.

In the operation of the embodiment, the re-output direction of the voice signal is transmitted from the telephone set 106 to the file communication apparatus 101 by pushing the predetermined keys of the telephone set 106.

Specifically, the above-mentioned predetermined key operation is to push an asterisk key twice. A signal by pushing the asterisk key is transmitted to the telephone control portion 126 of the file communication apparatus 101 (Step 15), and the telephone control portion 126 detects the signal of the key as the re-output request signal. Next, the telephone control portion 126 informs the main control portion 127 of a notice indicating that the telephone control portion 126 received the re-output direction. By receiving the notice, the main control portion 127 directs the code processing portion 124 to retransmit the voice data stored in the memory portion to the DA conversion portion 125 (Step 16). After receiving the re-output direction, the code processing portion 124 transmits the voice data to the DA converting portion 125 again (Step 17). Then, the DA conversion portion 125 converts the digital voice data to the analog voice signal, and then transmits the analog voice signal of the voice file to the telephone set 106 through the telephone control portion 126 (Step 18).

By pushing the predetermined key of the telephone set 106, the user can hear again the sound of the voice file which the user failed to hear.

Next, if the user hangs up the receiver of the telephone set 106, the telephone control portion 126 receives a response (an on-hook signal) (Step 19). Upon reception of the on-hook signal, the telephone control portion 126 informs the main control portion 127 of a notice indicating that the telephone control portion 126 detected the on-hook of the telephone set 106. After receiving the notice, the main control portion 127 directs the code processing portion 124 to delete the voice file in the memory portion (Step 20).

Since the voice file stored in the memory portion of the code processing portion 124 is deleted automatically by the direction of the main control portion 127, it is not necessary to leave the voice file. Therefore, it causes the storage capacity of the memory portion to be small.

As explained above, according to this embodiment, in the communication system in which the personal computer connected to the network and the analog standard telephone set are corresponded to each other, it is possible to realize the reproduction function in high user convenience and high cost performance.

Referring to the drawings, the 2nd embodiment of the invention is explained as follows.

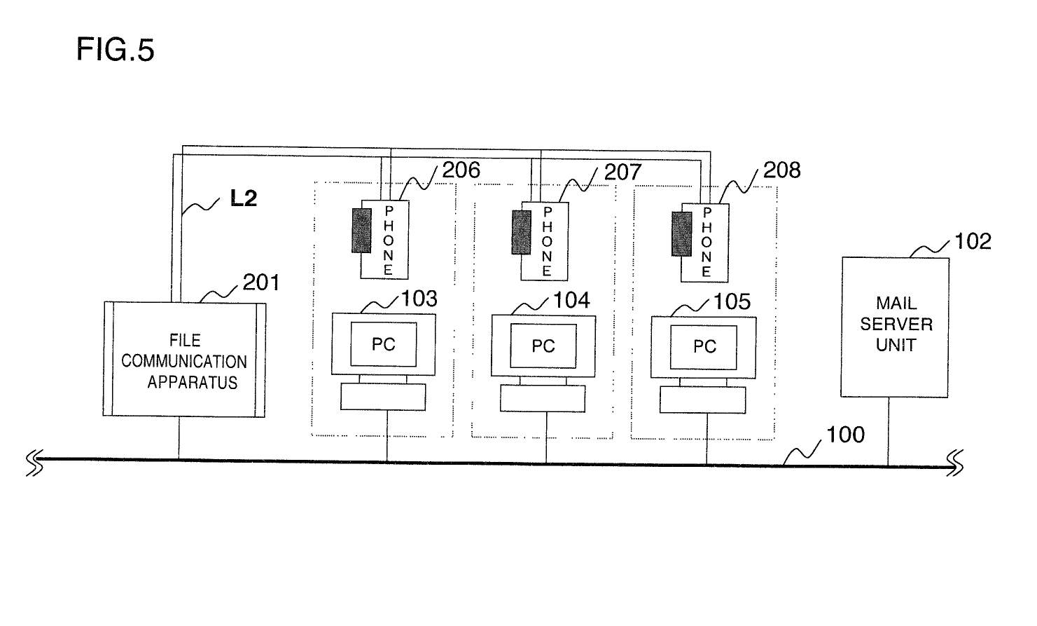

First, with reference to FIG. 5, a schematic structure of the communication system in the 2nd embodiment of the invention is explained as follows.

In this embodiment, the telephone set is the type of the analog proprietary telephone set. The telephone set of this type has an analog voice channel and a signal control channel separately, and the file communication apparatus can set a speaker of the telephone set to be on or off.

A file communication apparatus 201, a mail server unit 102, and three personal computers 103, 104 and 105 are connected with a Local Area Network (LAN) 100. Also, three extension telephone sets 206, 207 and 208 are connected with the file communication apparatus 201 and each other through a connection line L2. Further, each personal computer 103, 104 or 105 is disposed in correspondence with one of the telephone sets 206, 207 and 208. The connection line L2 has an analog communication line and a digital signal communication line. Each personal computer 103, 104 or 105 connected with the LAN 100 is capable of transmitting/receiving an E-mail to/from the mail server unit 102.

Also, since the personal computer of the 2nd embodiment has the same structure and the same function as those of the personal computer of the 1st embodiment, the detailed explanation about the personal computer is omitted.

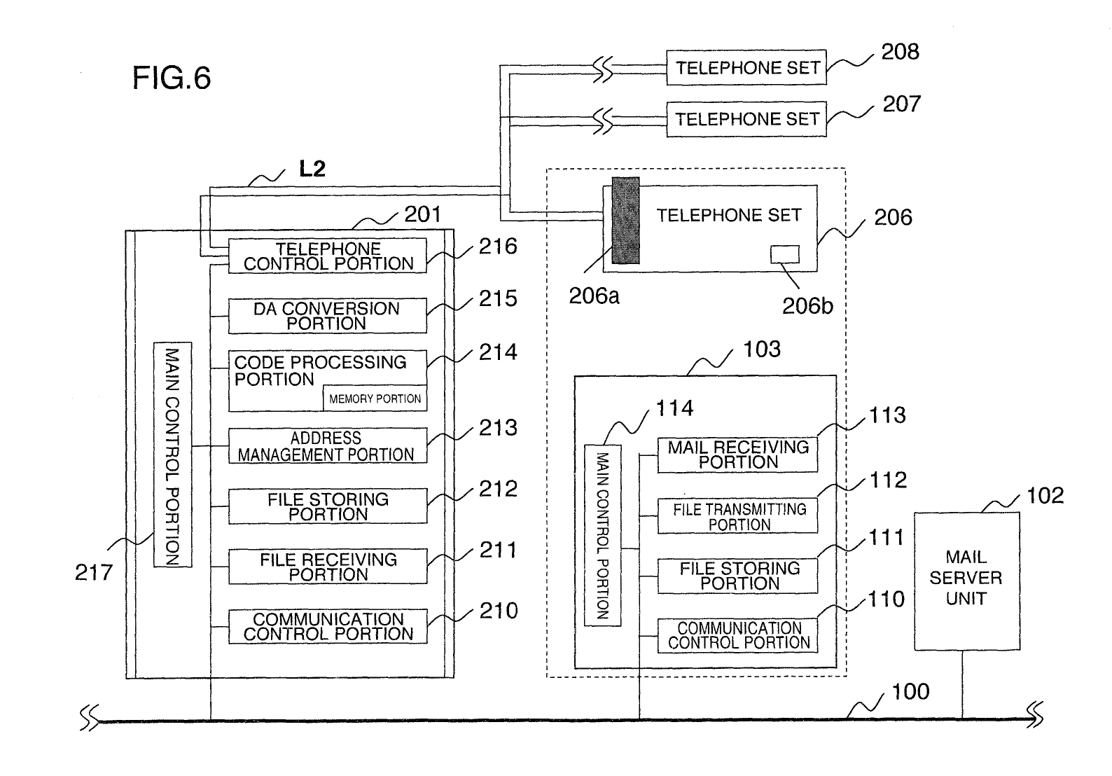

Next, with reference to FIG. 6, the file communication apparatus 201 of the embodiment is explained.

In detail, the file communication apparatus 201 has a LAN controller which transmits and receives an Ethernet packet on the LAN 100, and lots of software such as a driver software which controls the operation of the LAN controller, and a software which controls the network protocol in communication of the Ethernet packets on the Ethernet, etc.

With reference to the functional block diagram of FIG. 6, the file communication apparatus 201 has a communication control portion 210 which performs data communications through the LAN 100. The communication control portion 210 has a controller which transmits an Ethernet packet, the software which controls the operation of the controller, and the software for network communication.

A file receiving portion 211 receives a voice file through the communication control portion 210. Also, a file storing portion 212 stores the voice file which the file receiving portion 221 received. An address management portion 213 stores the extension numbers of the telephone sets and the network addresses on the LAN of the personal computers, and each extension number corresponds to one of the network addresses of the personal computers as pairs (referring to FIG. 3).

Next, with reference to FIGS. 3 and 6, the construction of data stored in the address management portion 213 of the file communication apparatus 201 is explained.

Referring to FIG. 6, the file communication apparatus 201 is connected with the telephone sets for extension 206, 207 and 208. Also, the network addresses are added to the personal computers 103, 104 and 105. The network addresses and the extension numbers of the telephone sets are stored in the address management portion 213 with each addresses corresponded to one of the extension numbers as pairs. Specifically, the telephone set 206 has the extension number “1” corresponding to the network address <192.168.0.1> which the personal computer 103 has. Also, the telephone set 207 has the extension number “2” corresponding to the network address <192.168.0.2> which the personal computer 104 has. Furthermore, the telephone set 208 has the extension number “3” corresponding to the network address <192.168.0.3> which the personal computer 105 has.

Further, a code processing portion 214 processes the received voice file according to the encoding method of a DA conversion portion 215 so that the DA conversion portion 215 can reproduce the voice file, stores the processed voice file (hereinafter referring to as “voice data”) in the memory portion of the code processing portion 214, and transmits periodically a predetermined amount of the digital voice data according to an encoding rate of the DA conversion portion 215. Moreover, the DA conversion portion 215 has the function for converting the digital voice data into an analog voice data.

Further, a telephone control portion 216 has a function as a communication interface to the above telephone sets. Specifically, the telephone control portion 216 has a function for transmitting a direction signal to transmit a bell signal to the telephone sets, a signal occurred by changing on-hook or off-hook state of the telephone set, and a signal occurred by pushing the keys or dialing, through the channel for data control being different from the analog channel for voice communication.

Further, the telephone control portion 216 has a function for communicating a bell signal, an on-hook-state detection signal of a telephone, and a tone-dial detection. Also, a main control portion 217 controls the above portions of the file communication apparatus 201.

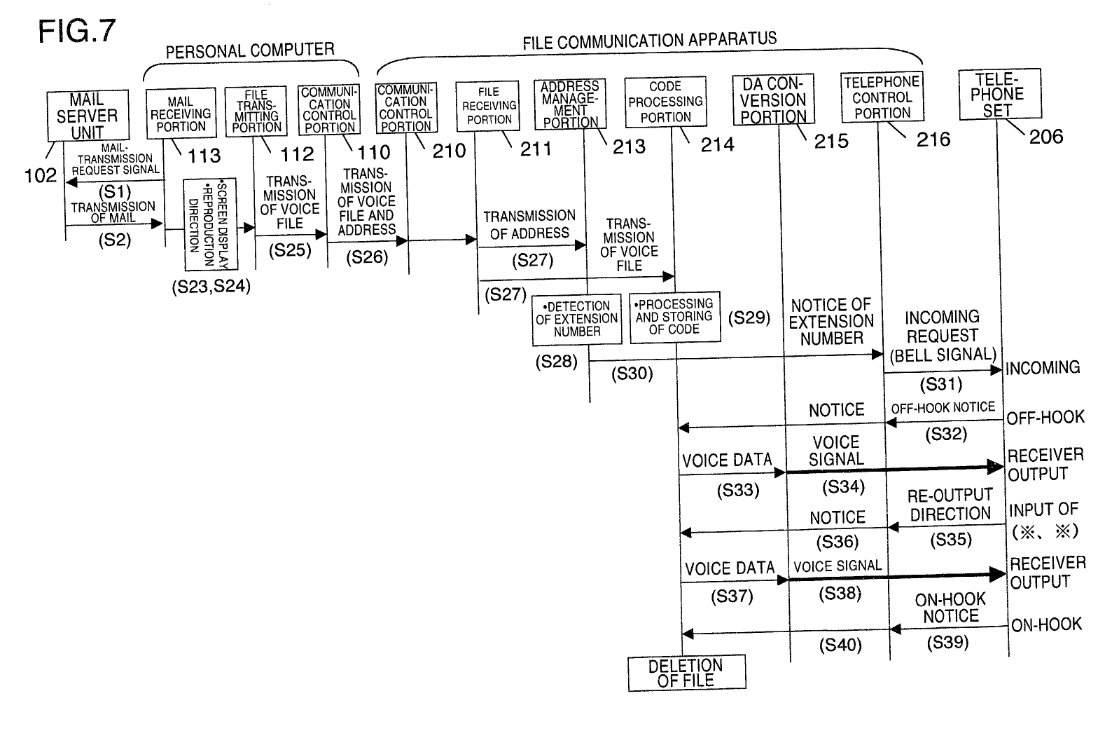

With reference to FIGS. 5 to 7, the schematic sequence flow in the operation of the communication system of the embodiment structured as above is explained as follows.

Specifically, the operation processes from when an E-mail with a voice file from the mail server unit 102 is received by the personal computer 103, until when the telephone set 206 corresponding to the personal computer 103 outputs a voice signal of the voice file received through the file communication apparatus 201 is explained.

First, the personal computer 103 which has the network address <192.168.0.1> transmits a mail-transmission request signal to the mail server unit 102 (Step 21). The mail server unit 102 detects an ID password from the personal computer 103, and if it corresponds, transmits the E-mail to the personal computer 103 (Step 22). Next, the mail receiving portion 113 of the personal computer 103 receives the E-mail with the voice file from the mail server unit 102 through the communication control portion 110, and the personal computer 103 displays the contents of the E-mail on the display screen (Step 23).

Since the voice file is attached to the E-mail, the icon of the voice file is displayed on the display screen of the personal computer 103 (not shown). Then, a user performs a voice reproduction direction through the display screen by clicking a computer mouse with a cursor superimposed on the icon of the voice file (Step 24). That is, by the click, the main control portion 114 transmits a transmission direction to the file transmitting portion 112 after receiving the voice reproduction direction. Next, by receiving the transmission direction, the file-transmitting portion 112 forwards the voice file from the file storing portion 113 to the communication control portion 110 (Step 25). The communication control portion 110 has a memory in which the network address of the file communication apparatus 201 was stored. The communication control portion 110 is set so as to forward the voice file to the file communication apparatus 201 by receiving the above direction.

Next, the communication control portion 110 forwards the voice file to the file communication apparatus 201 in compliance with the communication protocol after adding the network address of the personal computer 103 to a header portion of the voice file in compliance with the communication protocol (Step 26).

Next, in the file communication apparatus 201, the file receiving portion 211 receives the voice file and the network address attached to the header portion of the voice file, and stores them in the file storing portion 212.

Further, the main control portion 217 transmits the network address <192.168.01> of the personal computer 103 to the address management portion 213 (Step 27). Simultaneously, the main control portion 217 forwards the voice file stored in the file storing portion 212 to the code processing portion 214 (Step 27). Also, the file storing portion 212 deletes the voice file automatically after transmitting the voice file to the code processing portion 214. The voice file is capable of being deleted at step 40 by the direction of the main control portion 217.

After receiving the network address, the address management portion 213 detects the extension number “1” corresponding to the received network address <192.168.01> on the basis of the relationship (refer to FIG. 3) between the network addresses and the extension numbers (Step 28). The address management portion 213 informs the main control portion 217 of a notice indicating that the corresponding extension number existed in the relationship. Next, the code processing portion 214 processes the voice file in compliance with the encoding method of the DA conversion portion 215, and stores the processed voice file (hereinafter referring to as “voice data”) in the memory portion (Step 29).

Further, after receiving the notice, the main control portion 217 directs the address management portion 213 to transmit the extension number “1” to the telephone control portion 216 (Step 30). Then, the telephone control portion 216 transmits a bell signal (incoming signal) as an off-hook request to the telephone set 206 through the signal control channel (digital signal line) (Step 31). The telephone set 206 generates a bell sound by receiving the bell signal.

When the user hangs off the receiver of the telephone set 206, an off-hook signal (response signal) is transmitted from the telephone set 206 to the telephone control portion 216 of the file communication apparatus 201 through the signal control channel (digital signal line) (Step 32). Next, the telephone control portion 216 detects the response signal, and transmits the detection result to the main control portion 217. Furthermore, the main control portion 217 directs the code processing portion 214 to transmit the voice data to the DA conversion portion 215.

Next, the code processing portion 214 transmits the voice data to the DA conversion portion 215 according to the coding sampling cycle and the number of coding bits of the DA conversion portion 215 (Step 33). Then, the DA conversion portion 215 converts the digital voice data to the analog voice signal, and then transmits the analog voice signal to the telephone set 206 through the telephone control portion 216 and the analog voice channel (Step 34).

The analog voice signal is adapted to be converted to sound in the telephone set 206. Finally, the telephone set 206 outputs the voice file as sound from the receiver of the telephone set 206.

As explained above, the user can hear the sound of the voice file certainly from the start by receiving the analog voice signal of the voice file which is generated by transmitting the digital voice data from the code processing portion 214 to the DA converting portion 215, when the user hangs off the receiver of the telephone set 206.

If the bell signal of the file communication apparatus 201 is different from the bell signal of the extension telephone set 206, the user can know whether the voice signal have reached or not.

Next, after finishing transmitting the voice file, the code processing portion 214 sends a notice of the voice-file transmission finishing to the main control portion 217. The main control portion 217 directs the telephone control portion 216 to transmit the reorder tone signal indicating the voice-file transmission finishing to the telephone set 206 through the signal control channel (digital signal line), and waits for a response indicating that the line was disconnected (the on-hook signal) from the telephone set 206.

In the embodiment of the invention, however, the user can hear the sound of the voice file from the start again by performing a predetermined key input operation while the telephone control portion 216 is outputting the voice signal or after the telephone control portion 216 finishes transmitting the voice signal.

In the operation of the embodiment, the re-output direction of the voice signal is transmitted from the telephone set 206 to the file communication apparatus 201 by pushing the predetermined keys of the telephone set 206.

Specifically, the above-mentioned predetermined key operation is to push an asterisk key twice. A signal by pushing the asterisk key is transmitted to the telephone control portion 216 of the file communication apparatus 201 through the signal control channel (digital signal line) (Step 35). The telephone control portion 216 transmits the signal to the main control portion 217. Then, the main control portion 217 detects the signal of the key as a re-output request signal. Next, the main control portion 217 directs the code processing portion 214 to retransmit the voice data to the DA conversion portion 215 (Step 36). After receiving the re-output direction, the code processing portion 214 forwards the digital voice data to the DA conversion portion 215 again (Step 37). Then, the DA conversion portion 215 converts the digital voice data into the analog voice signal, and then forwards the analog voice signal to the telephone set 206 through the telephone control portion 216 and the analog voice channel (Step 38).

By pushing the predetermined key of the telephone set 206, the user can hear again the sound of the voice file which the user failed to hear.

Next, if the user hands up the receiver of the telephone set 206, the telephone control portion 216 receives the response (the on-hook signal) (Step 39). Upon reception of the response, the telephone control portion 216 informs the main control portion 217 of a notice indicating that the telephone control portion 216 detected the on-hook of the telephone set 206. After receiving the notice, the main control portion 217 directs the code processing portion 214 to delete the voice file in the memory portion (Step 40).

Since the voice file stored in the memory portion of the code processing portion 214 is deleted automatically by the direction of the main control portion 217, it is not necessary to leave the voice file. Therefore, it causes the storage capacity of the memory portion to be small.

Furthermore, with reference to the FIG. 6, the telephone set 206 of the system according to the embodiment has a speaker 206b on the telephone main portion side, apart from the receiver side. Therefore, the user can hear the caller's voice from the speaker 206b without hanging off the receiver of the telephone set 206. This conventional function is so called “hands-free” function.

Next, operation of the file communication apparatus 201 and the telephone set 206 in the embodiment of the invention when the telephone set 206 is set in the hands-free mode is explained.

By the address management portion 213 of the file communication apparatus 201, the user can set the “hands-free” mode and the ordinary calling mode in the telephone set 206, and can register them in the address management portion 213.

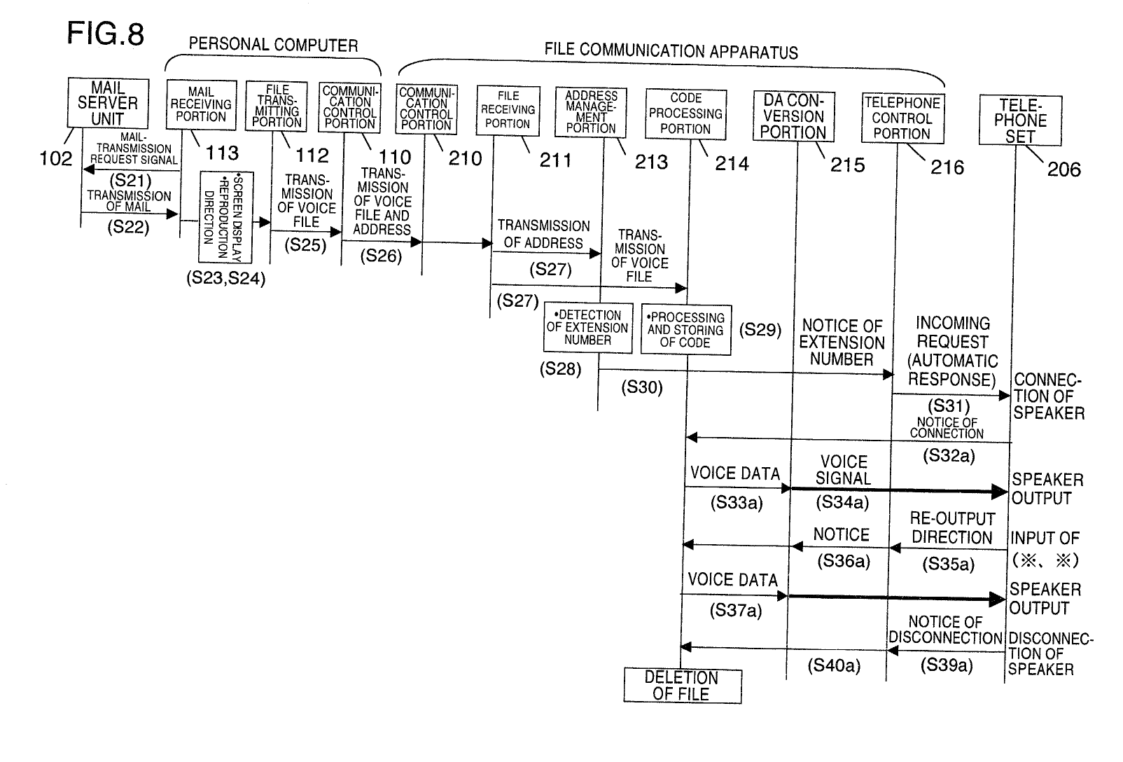

With reference to the FIGS. 6 and 8, the operational sequence of the communication system in the “hands-free” mode in the embodiment of the invention is explained as follows.

Also, referring to FIG. 8, since the sequence from steps 21 to 31 is the same as that from steps 21 to 31 in the mode explained before, the detailed explanations about the sequence in those steps are omitted.

In brief, by the voice reproduction direction from the personal computer 103, the address management portion 213 of the file communication apparatus 201 notifies the extension number “1” through the digital signal control channel to the telephone control portion 216. The telephone control portion 216 transmits an incoming signal (incoming request for automatically connecting the telephone line) to the telephone set 206 corresponding to the extension number “1”. After receiving the incoming signal, the corresponding telephone set 206 turns to be available in outputting sound from the speaker 206b automatically.

Then, the telephone set 206 informs the main control portion 217, through the telephone control portion 216, of a notice indicating that the speaker 206b of the telephone set 206 was changed to be available to output sound (step 32a), and the main control portion 217 directs the code processing portion 214 to forward the voice data to the DA conversion portion 215. By receiving the direction, the code processing portion 214 transmits the voice data to the DA conversion portion 215 (step 33a). Then, the DA conversion portion 215 converts the digital voice data into the analog voice signal, and then forwards the analog voice signal to the telephone set 206 through the telephone control portion 216 and the analog voice signal channel (step 34a). After receiving the analog voice signal, the telephone set 206 outputs the sound from the speaker 206b. In this mode, a bell ring signal from the file communication apparatus 201 and an off-hook notice from the telephone set 206 are not necessary to transmit the analog voice signal to the telephone set 206.

If the user pushes the predetermined key of the telephone set 206 while the speaker 206b is outputting the sound of the voice signal or after the speaker 206b finishes outputting the sound, the telephone set 206 transmits the signal as the request for reproduction of the sound, to the telephone control portion 216 of the file communication apparatus 201 through the signal control channel (step 35a). Then, the telephone control apparatus 216 transmits the signal to the main control portion 217, and the main control portion 216 directs the code processing portion 214 to retransmit the voice data to the DA conversion portion 215 (step 36a). After receiving the direction, the code processing portion 214 forwards the voice data to the DA conversion portion 215 (step 37a). Then, the DA conversion portion 215 converts the digital voice data into the analog voice signal, and then forward the analog voice signal to the telephone set 206 through the telephone control portion 216 and the analog voice signal channel (step 38a). After receiving the analog voice signal, the telephone set 206 outputs the sound from the speaker 206b, so that the user can hear the sound from the start again.

Further, by pushing an off switching for disconnecting the line of the telephone set 206 even while the sound is outputting from the speaker 206b, the signal by pushing the switch is transmitted to the main control portion 217 through the telephone control portion 216 and the digital signal control channel (step 39a). Then, the main control portion 217 directs the telephone control portion 216 to disconnect the line, and directs the code processing portion 214 to stop forwarding the analog voice data (step 40a). By receiving the direction, the code processing portion 214 stops forwarding the analog voice data, and deletes the voice data of the voice file stored in the memory portion.

In this embodiment, the speaker 206b of the telephone 206 set can be utilized as the speaker for the personal computer 103.

As explained above, according to this embodiment, in the communication system in which the personal computer connected to the network and the analog proprietary telephone set are corresponded to each other, it is possible to realize the reproduction function in high user convenience and high cost performance.

Referring to the drawings, the 3rd embodiment of the invention is explained as follows.

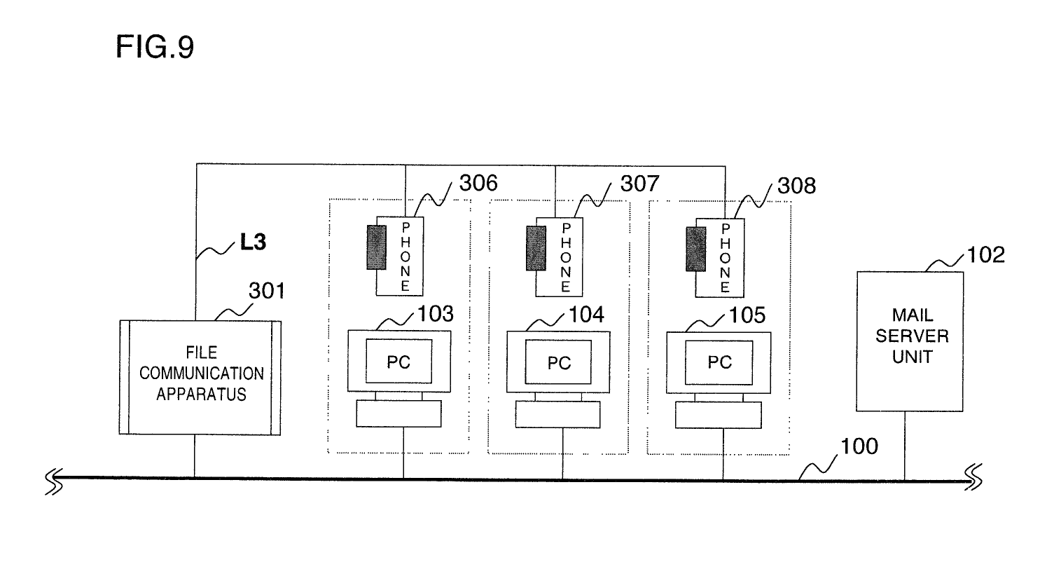

First, with reference to FIG. 9, a schematic structure of the communication system in the 3rd embodiment of the invention is explained as follows.

In this embodiment, the telephone set is the type of the digital telephone set.

A file communication apparatus 301, a mail server unit 102, and three personal computers 103, 104 and 105 are connected with a Local Area Network (LAN) 100. Also, three extension telephone sets 306, 307 and 308 are connected with the file communication apparatus 301 and each other through a connection line L3. The connection line L3 has a digital signal line for communication for a digital voice signal and a digital control signal. Further, each personal computer 103, 104 or 105 is disposed in correspondence with one of the telephone sets 306, 307 and 308. Each personal computer 103, 104 or 105 connected with the LAN 100 is capable of transmitting/receiving an E-mail to/from the mail server unit 102. Moreover, since the personal computer of the 3rd embodiment has the same structure and the same function as those of the personal computer of the 1st embodiment, the explanation about the personal computer is omitted.

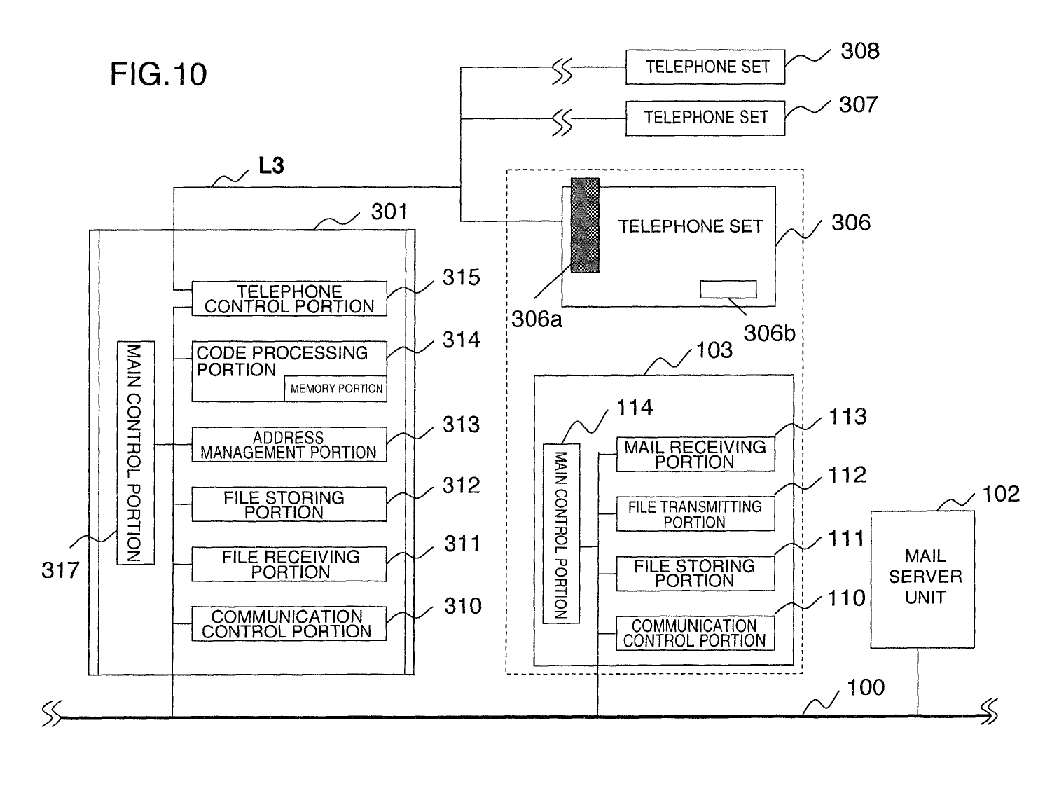

Next, with reference to FIG. 10, the file communication apparatus 301 of the embodiment is explained.

In detail, the file communication apparatus 301 has a LAN controller which transmits and receives an Ethernet packet on the LAN 100, and lots of software such as a driver software which controls the operation of the LAN controller, and a software which controls the network protocol in communication of the Ethernet packets on the Ethernet, etc.

Also, the file communication apparatus 301 has a communication control portion 310 which performs data communications through the LAN 100. The communication control portion 310 has a controller which transmits an Ethernet packet, the software which controls the operation of the controller, and the software for network communication.

A file receiving portion 311 receives a voice file through the communication control portion 310. Also, a file storing portion 312 stores the voice file which the file receiving portion 311 received. An address management portion 313 stores the extension numbers of the telephone sets and the network addresses on LAN of the personal computers. Each extension number corresponds to one of the network addresses of the personal computers as pairs (referring to FIG. 3).

Next, with reference to FIGS. 3 and 10, the construction of data stored in the address management portion 313 of the file communication apparatus 301 is explained. Referring to FIG. 10, the file communication apparatus 301 is connected with the telephone sets for extension 306, 307 and 308. Also, the network addresses are added to the personal computers 103, 104 and 105. The network addresses and the extension numbers of the telephone sets 306, 307 and 308 are stored in the address management portion 313 with each network address corresponded to one of the extension numbers as pairs. Specifically, the telephone set 306 has the extension number “1” corresponding to the network address <192.168.0.1> which the personal computer 103 has. Also, the telephone set 307 has the extension number “2” corresponding to the network address <192.168.0.2> which the personal computer 104 has. Furthermore, the telephone set 308 has the extension number “3” corresponding to the network address <192.168.0.3> which the personal computer 105 has.

Further, the code processing portion 314 processes the received voice file according to the encoding method of a telephone control portion 315, stores the processed voice file (hereinafter referring to as “voice data”) in the memory portion of the code processing portion 314, and transmits periodically a predetermined amount of the voice data to the telephone control portion 315 according to an encoding rate of the telephone control portion 315. Moreover, the telephone control portion 315 has a function for a communication interface to the telephone sets. The voice signal can be converted to sound in the telephone set. Specifically, the telephone control portion 315 has a function for transmitting a direction signal to transmit a bell signal to the telephone set, a signal occurred by changing on-hook or off-hook state of the telephone set, and a signal by pushing the keys or dialing, through the channel for data communication. Further, the telephone control portion 315 has a function for communicating a bell signal, a signal which indicates the detection of on-hook of a telephone set and the detection of tone dial. Also, the main control portion 317 controls the above portions in the communication apparatus 301.

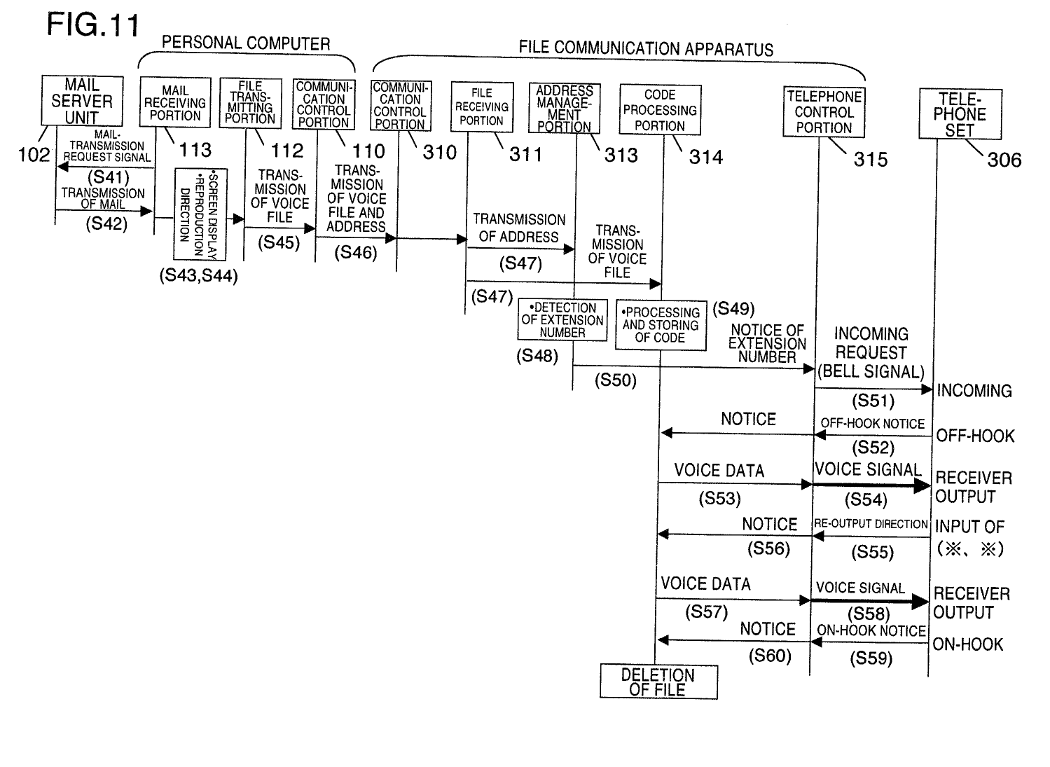

Next, with reference to FIGS. 10 and 11, the schematic sequence flow in the operation of the communication system of the embodiment structured as above is explained.

Specifically, the operation processes from when an E-mail with a voice file from the mail server unit 102 is received by the personal computer 103, until when the telephone set 306 corresponding to the personal computer 103 outputs a voice signal of the voice file received through the file communication apparatus 301 is explained.

First, the personal computer 103 which has the network address <192.168.0.1> transmits a mail-transmission request to the mail server unit 102 (Step 41). The mail server unit 102 detects an ID password from the personal computer 103, and if it corresponds, transmits the E-mail to the personal computer 103 (Step 42). Next, the mail receiving portion 113 of the personal computer 103 receives the E-mail with the voice file from the mail server unit 102 through the communication control portion 110, and the personal computer 103 displays the contents of the E-mail on the display screen (Step 43).

Since the voice file is attached to the E-mail, the icon of the voice file is displayed on the display screen of the personal computer 103 (not shown). Then, a user performs a voice reproduction direction through the display screen by clicking a computer mouse with a cursor superimposed on the icon of the voice file (Step 44). That is, by the click, the main control portion 114 transmits a transmission direction to the file transmitting portion 112 after receiving the voice reproduction direction. By receiving the transmission direction, the file transmitting portion 112 forwards the voice file to the communication control portion 110 (Step 45). The communication control portion 110 has a memory in which a network address of the file communication apparatus 301 was stored. The communication control portion 110 is set so as to forward the voice file to the file communication apparatus 301 by receiving the above direction.

Next, the communication control portion 110 forwards the voice file to the file communication apparatus 301 in compliance with the communication protocol after adding the network address of the personal computer 103 to a header portion of the voice file in compliance with the communication protocol (Step 46).

Next, in the file communication apparatus 301, the file receiving portion 311 receives the voice file and the network address attached to the header portion of the voice file, and stores them in the file storing portion 312.

Furthermore, the main control portion 317 transmits the network address <192.168.01> of the personal computer 103 to the address management portion 313 (Step 47). Simultaneously, the main control portion 317 forwards the voice file stored in the file storing portion 312 to the code processing portion 314 (Step 47). Also, the file storing portion 312 deletes automatically the voice file after transmitting the voice file to the code processing portion 314. The voice file is capable of being deleted at step 60 by the direction of the main control portion 317.

After receiving the network address, the address management portion 313 detects the extension number “1” corresponding to the received network address <192.168.01> on the basis of the relationship (refer to FIG. 3) between the network addresses and the extension numbers (Step 48). The address management portion 313 informs the main control portion 317 of a notice indicating that the corresponding extension number existed in the relationship. Next, the code processing portion 314 converts the voice file into a voice file (hereinafter referring to as “voice data”) in compliance with the coding method which can reproduce the telephone control portion 315, and stores the voice data in the memory portion (Step 49).

Further, after receiving the notice, the main control portion 317 directs the address management portion 313 to transmit the extension number “1” to the telephone control portion 315 (Step 50). Then, the telephone control portion 315 transmits an incoming signal (bell signal) as an off-hook request to the telephone set 306 (Step 51). The telephone set 306 generates a bell sound by receiving the bell signal.

When the user hangs off the receiver of the telephone set 306, an off-hook signal (response signal) is transmitted from the telephone set 306 to the telephone control portion 315 of the file communication apparatus 301 (Step 52). Next, the telephone control portion 315 detects the response signal, and transmits the detection result to the main control portion 317. Furthermore, the main control portion 317 directs the code processing portion 314 to transmit the voice data to the telephone control portion 315.

Next, the code processing portion 314 transmits the voice data to the telephone control portion 315 according to the coding sampling cycle and the number of coding bits of the telephone control portion 315 (Step 53). Then, the telephone control portion 315 converts the digital voice data into a digital voice signal, and transmits the digital voice signal to the telephone set 306 (Step 54). The digital voice signal is adapted to be converted to sound in the telephone set 306. Finally, the telephone set 306 outputs the contents of the voice file as sound from the receiver of the telephone set 306.

As explained above, the user can hear sound of the voice file certainly from the start by receiving the digital voice signal of the voice file which is generated by transmitting the voice data from the code processing portion 314 to the telephone control portion 315, when the user hangs off the receiver of the telephone set 306.

If the ring signal of the file communication apparatus 301 is different from the ring signal of the extension telephone set 306, the user can know whether the voice mail have reached or not.

Next, after finishing transmitting the voice file, the code processing portion 314 sends a notice indicating that the transmission of the voice file is finished, to the main control portion 317. Further, the main control portion 317 directs the telephone control portion 315 to transmit the reorder tone signal indicating that the transmission of the voice file is finished, to the telephone set 306, and waits for a response indicating that the line was disconnected (the on-hook signal) from the telephone set 306.

In the embodiment of the invention, however, the user can hear the sound of the voice file from the start again by performing a predetermined key input operation while the telephone control portion 315 is outputting the digital voice signal or after the telephone control portion 315 finishes transmitting the digital voice signal.

In the operation of the embodiment, the re-output direction of the voice signal is transmitted from the telephone set 306 to the file communication apparatus 301 by pushing the predetermined keys of the telephone set 306.

Specifically, the above predetermined key operation is to push an asterisk key twice. A signal by pushing the asterisk key is transmitted to the telephone control portion 315 of the file communication apparatus 301 (Step 55). The telephone control portion 315 transmits the signal to the main control portion 317 (step 56), and the main control portion 317 detects the signal of the key as a re-output request signal. By receiving the direction, the main control portion 317 directs the code processing portion 314 to retransmit the digital voice data stored in the memory portion to the telephone control portion 315. Then, the code processing portion 314 forwards the voice data stored in the code processing portion 314 to the telephone control portion 315 again (Step 57). Then, the telephone control portion 315 transmits the digital voice signal of the voice file to the telephone set 306 by the direction (Step 58). The digital voice signal is adapted to be converted to sound in the telephone set 306.

By pushing the predetermined key of the telephone set 306, the user can hear again the sound of the voice file which the user failed to hear.

Next, if the user hangs up the receiver of the telephone set 306, the telephone control portion 315 receives the response (the on-hook signal) (Step 59). By the reception of the response, the telephone control portion 315 detects the on-hook signal, and informs the main control portion 317 of a notice indicating that the telephone control portion 315 detected the on-hook of the telephone set 306. After receiving the notice, the main control portion 317 directs the code processing portion 314 to delete the voice data in the memory portion (Step 60).

Since the voice data stored in the memory portion of the code processing portion 314 is deleted automatically by the direction of the main control portion 317, it is not necessary to leave the voice file. Therefore, it causes the storage capacity of the memory portion to be small.

As explained above, according to this embodiment, in the system in which the personal computer connected to the network and the digital telephone set are corresponded to each other, it is possible to realize the reproduction function in high user convenience and high cost performance, and by the system having a compact construction in design.

Furthermore, with reference to FIG. 10, the telephone set 306 of the communication system in the embodiment has a speaker 306b on the telephone main portion side. Therefore, the user can hear the caller's voice from the speaker 306b without hanging off the receiver of the telephone set 306, apart from the receiver side. This conventional function is so called “hands-free” function.

Next, when the telephone set 306 is set in the hands-free mode, operation of the file communication apparatus 301 and the telephone set 306 in the embodiment of the invention is explained.

By the address management portion 313 of the file communication apparatus 301, the user can set the “hands-free” mode and the ordinary calling mode of the telephone set 306, and can register them in the address management portion 313.

With reference to the FIGS. 9, 10 and 12, the operational sequence of the communication system in the “hands-free” mode in the embodiment of the invention is explained as follows.

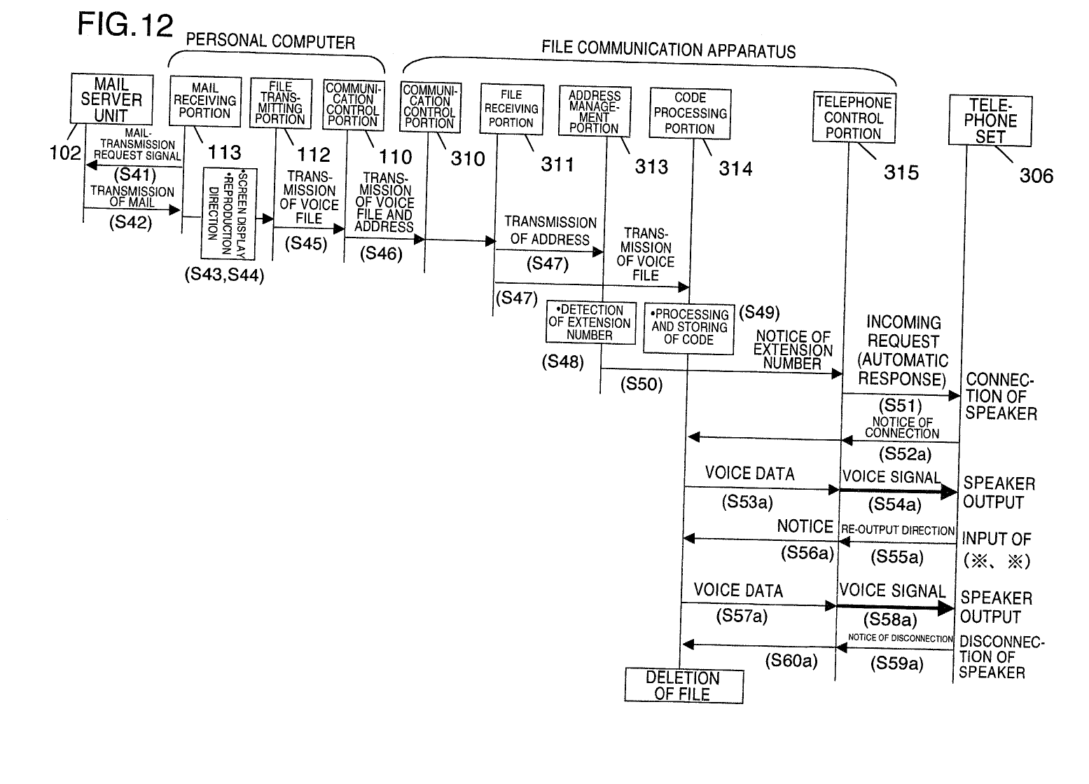

Also, referring to FIG. 12, since the sequence from steps 41 to 51 is the same as that from steps 41 to 51 in the ordinary calling mode explained before, the detailed explanations about the sequence in those steps are omitted.

In brief, according to the voice reproduction direction from the personal computer 103, the address management portion 313 of the file communication apparatus 301 notifies the extension number “1” to the telephone control portion 315. Then, the telephone control portion 315 transmits an incoming signal (request for connecting the telephone line) to the telephone set 306 corresponding to the extension number “1”. After receiving the incoming signal, the corresponding telephone set 306 turns to be available in outputting sound from the speaker 306b automatically.

Then, the telephone set 306 informs the main control portion 317 through the telephone control portion 316 of a notice indicating that the speaker 306b of the telephone set 306 is changed to be available to output sound (step 52a). The main control portion 317 directs the code processing portion 314 to transmit the voice data.

By receiving the direction, the code processing portion 314 transmits the voice data to the telephone control portion 315 (step 53a). Then, the telephone control portion 315 converts the digital voice data into the digital voice signal, and forwards the digital voice signal to the telephone set 306 (step 54a). In this mode, a bell signal from the file communication apparatus 301 and an off-hook notice from the telephone set 306 are not necessary to transmit the digital voice signal to the telephone set 306.

If the user pushes the predetermined key of the telephone set 306 while the speaker 306b is outputting sound of the digital voice signal or after the speaker 306b finishes outputting the sound, the telephone set 306 transmits the signal as the request for reproduction of the sound, to the telephone control portion 315 of the file communication apparatus 301 (step 55a). Further, the telephone control portion 315 transmits the signal to the main control portion 317. Further, the main control portion 317 directs the code processing portion 314 to retransmit the voice data to the telephone control portion 315 (step 56a). Next, the code processing portion 314 transmits the digital voice data to the telephone control portion 315 (step 57a). Then, the telephone control portion 315 forwards the digital voice signal converted from the digital voice data, to the telephone set 306. Finally, since the telephone set 306 outputs the sound from the speaker 306b by receiving the digital voice signal, the user can hear the sound from the start again.

Further, by pushing an on and off switch for connecting and disconnecting the line of the telephone set 306 even while the sound is outputting from the speaker 306b, the signal by the pushing the switch is transmitted to the main control portion 317 through the telephone control portion 315 (step 59a). Then, the main control portion 317 directs the telephone control portion 315 to disconnect the line, and directs the code processing portion 314 to stop forwarding the voice data (step 60a). By receiving the direction, the code processing portion 314 deletes automatically the voice data of the voice file in the memory portion (step 60a).

In this embodiment, the speaker 306b of the telephone set 306 can be utilized as the speaker for the personal computer 103.

As explained above, according to this embodiment, in the system in which the personal computer connected to the network and the digital telephone set are corresponded to each other, it is possible to realize the reproduction function in high user convenience and high cost performance.

Many modifications and variations of the present invention are possible in the light of the above techniques. It is therefore to be understood that within the scope of the appended claims, the invention may be practiced otherwise than as specifically described.

What is claimed is:

1. A communication system comprising:
a mail server for receiving and storing a mail, to which a voice file is attached, through a network;
a plurality of computers for receiving the mail from said mail server through said network;
a file communication apparatus for receiving the voice file through said network; and
a plurality of telephone sets connected to said file communication apparatus, each of said telephone sets being disposed in correspondence with one of said computers,
wherein said communication apparatus includes:
management means for storing information about a corresponding relationship between telephone numbers of said telephone sets and network addresses of said computers;
receiving means for receiving the network address and the voice file which are transmitted from one of said computers;
storing means for storing the voice file received by said receiving means;
conversion means for converting the stored voice file into a voice signal;
transmitting means for transmitting the voice signal; and
control means for obtaining the telephone number corresponding to the received network address based on the relationship in said management means, and for controlling said transmitting means to transmit the voice signal to said telephone set corresponding to the obtained telephone number.

2. A communication system according to claim 1, wherein said control means controls said transmitting means to start transmitting the voice signal to said telephone set by receiving a first predetermined signal from said telephone set after transmitting a second predetermined signal to said telephone set.

3. A communication system according to claim 1, wherein
said telephone set has a speaker in a main portion of said telephone set; and
said control means controls said transmitting means to transmit the voice signal to said telephone set by receiving a request signal from said computer, so that said telephone set outputs sound of the voice signal from said speaker.

4. A communication system according to claim 1, wherein said control means controls said transmitting means to retransmit the voice signal to said telephone set by receiving a predetermined signal from said telephone set during transmission of the voice signal by said transmitting means or after transmitting the voice signal.

5. A communication system according to claim 1, wherein said control means deletes the voice file stored in said storing means, by receiving a predetermined signal from said telephone set.

6. A file communication apparatus capable of receiving a voice file through a network, comprising;
management means for storing information about a corresponding relationship between a telephone number of a telephone set and a network address of a computer;
receiving means for receiving the network address and the voice file which are transmitted from said computer;
storing means for storing the received voice file;
conversion means for converting the stored voice file into a voice signal;
transmitting means for transmitting the voice signal; and
control means for obtaining the telephone number corresponding to the received network address based on the relationship in said management means, and for controlling said transmitting means to transmit the voice signal to said telephone set corresponding to the obtained telephone number.

7. A communication system according to claim 6, wherein said control means controls said transmitting means to start transmitting the voice signal to said telephone set by receiving a first predetermined signal from said telephone set after transmitting a second predetermined signal to said telephone set.

8. A communication system according to claim 6, wherein
said telephone set has a speaker in a main portion of said telephone set; and
said control means controls said transmitting means to transmit the voice signal to said telephone set by receiving a request signal from said computer, so that said telephone set outputs sound of the voice signal from said speaker.

9. A communication system according to claim 6, wherein said control means controls said transmitting means to retransmit the voice signal to said telephone set by receiving a predetermined signal from said telephone set during transmission of the voice signal by said transmitting means or after transmitting the voice signal.

10. A communication system according to claim 6, wherein said control means deletes the voice file stored in said storing means, by receiving a predetermined signal from said telephone set.

11. A file communication unit comprising;
a telephone set;
receiving means for receiving a voice file through a network;
storing means for storing the received voice file;
conversion means for converting the stored voice file into a voice signal;
request means for transmitting a signal for requesting to connect a telephone line to said telephone set, to said telephone set by receiving the voice file;
transmitting means for transmitting the converted voice signal to said telephone set; and
control means for controlling said transmitting means to transmit the voice signal to said telephone set by receiving a predetermined signal from said telephone set.

12. A communication system according to claim 11, wherein said control means controls said transmitting means to start transmitting the voice signal to said telephone set by receiving a first predetermined signal from said telephone set after transmitting a second predetermined signal to said telephone set.

13. A communication system according to claim 11, wherein
said telephone set has a speaker in a main portion of said telephone set; and
said control means controls said transmitting means to transmit the voice signal to said telephone set by receiving a request signal from said computer, so that said telephone set outputs sound of the voice signal from said speaker.

14. A communication system according to claim 11, wherein said control means controls said transmitting means to retransmit the voice signal to said telephone set by receiving a predetermined signal from said telephone set during transmission of the voice signal by said transmitting means or after transmitting the voice signal.

15. A communication system according to claim 11, wherein said control means deletes the voice file stored in said storing means, by receiving a predetermined signal from said telephone set.
